(19) United States
(12) Patent Application Publication
(10) Pub. No.: US 2011/0318140 A1
(43) Pub. Date: Dec. 29, 2011

(54) HEIGHT ADJUSTMENT RING SPACER

(76) Inventor: Wen-Yao CHANG, Yuanlin Town (TW)

(21) Appl. No.: 12/822,340

(22) Filed: Jun. 24, 2010

(51) Int. Cl. F16B 43/00

(52) U.S. Cl. 411/535

(57) ABSTRACT

The present invention relates to a height adjustment ring spacer, including a ring-type gasket with at least one upper ring body and one lower ring body, in which plural staircase-type ladders formed in a side of each of the upper ring bodies and a side of each of the lower ring bodies make the ladders of the upper ring body and the lower ring body individually be placed at different linking engagements to increase or decrease the height in circumferential direction; the features of the present invention are that: there are a recess formed in every ladder of the above upper ring body, and a convex body formed in every ladder of the lower ring body, thus the recess of the upper ring body and the convex body of the lower ring body relatively plug and link each other to avoid the relative movement in circumferential and radial direction therein.

### BACKGROUND OF THE INVENTION

1. Field of the Invention

The present invention relates to bicycle steering components, or a height adjustment ring spacer for adjusting the height of the ring spacer of the similar pattern vehicle.

2. Description of the Prior Art

As shown in FIG. 1, the ring spacer is used for supporting the components height of the bike front; because of the difference in bodies of the riders, the height of the bike front and handles must be adjusted accordingly, to achieve good riding posture and prevent muscle from exercise injury.

The ring spacer is used for height adjustment, such as U.S. Pat. No. 6,892,604, in which a counterbore and a protrusion are placed at one side of every ring-type gasket to make gaskets stack each other and avoid the movement in radial direction, and staircase-type ladders placed in the spacer structure disclosed in the embodiments, to make gaskets stack each other to increase the height in circumferential direction through the ladders, however, although the height of the combined gaskets is changed through the ladders, the movement in circumferential direction will be caused through the external force on the gaskets, and the combined gaskets cannot be firm positioned, which is the shortcoming.

### SUMMARY OF THE INVENTION

Another object of the present invention is that, by way of structural components design, the various heights are achieved through the adjustment of the upper and lower ring bodies, and not only the manufactures do not need to produce multi-specification products, but also the customers do not worry to wrongly buy and reluctantly use the products with improper specification, therefore, the perfect industrial use and practical value are achieved.

For achieving the above object, the structural design of the present invention mainly includes a compound adjustment ring spacer constituted by an upper ring body overlapping a lower ring body, in which at least two or more multi-stage bump engaged ladders are placed at the stacking interface between the upper ring body and the lower ring body, every ladder set is circularly placed and rounds the annulus of the upper and lower ring bodies at predetermined interval range to implement decreasing or increasing engagement, a recess is placed at every ladder of the upper ring body, and a convex body is placed at the highest ladder of the lower ring body, when the engagement is implemented at the most convex ladder surface of the upper ring body with various ladder of the lower ring body, various supporting height is performed, thus, the various supporting height is easily achieved as needed.

### BRIEF DESCRIPTION OF THE DRAWINGS

FIG. 1 is a reference view showing the supporting height of the conventional bike front components;

FIG. 2 is a structural schematic view of the preferred embodiment of the present invention;

FIG. 3 is a structural exploded schematic view of the preferred embodiment of the present invention;

FIG. 4 is a structural exploded schematic view, in another view direction, of the preferred embodiment of the present invention;

FIG. 5 is a structural relationship schematic view (1) showing the adjustment for the supporting height of the adjustment ring spacer of the preferred embodiment of the present invention;

FIG. 6 is a structural relationship schematic view (2) showing the adjustment for the supporting height of the adjustment ring spacer of the preferred embodiment of the present invention;

FIG. 7 is a structural relationship schematic view (3) showing the adjustment for the supporting height of the adjustment ring spacer of the preferred embodiment of the present invention; and

FIG. 8 is an implementation status reference view of the present invention applying to bike front.

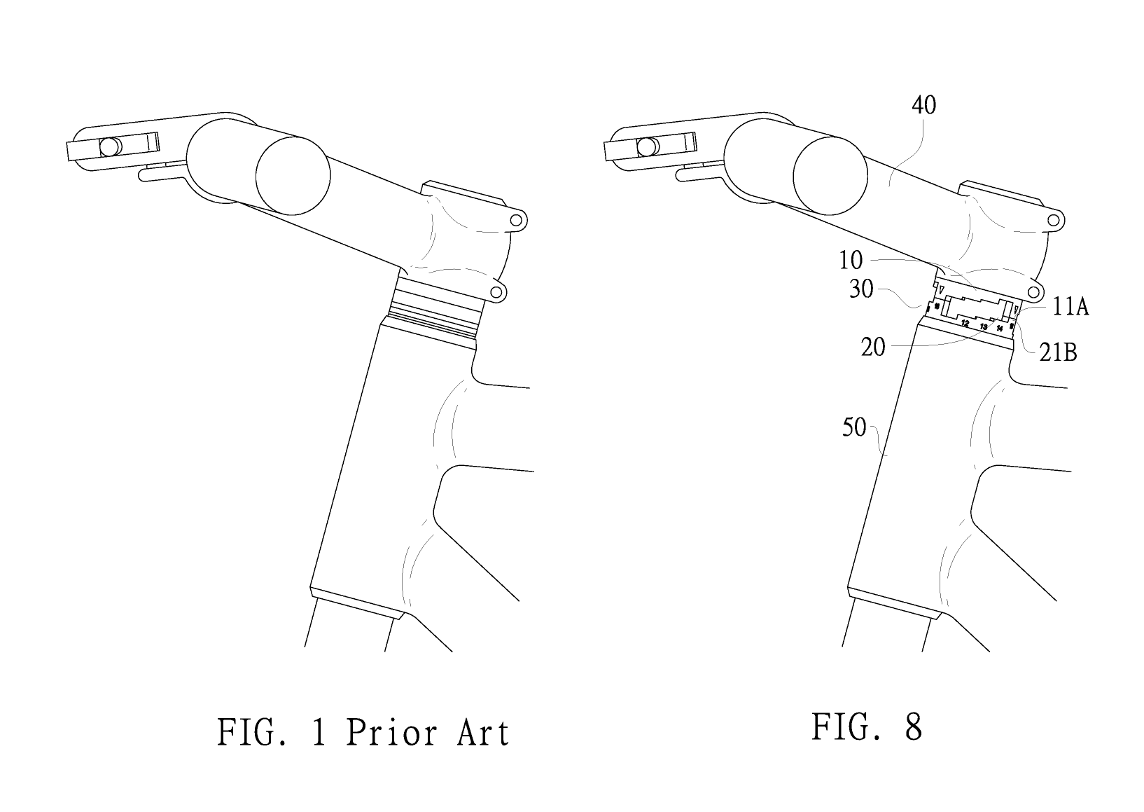

### DESCRIPTION OF MAIN COMPONENT SYMBOLS

(10): Upper ring body
(11): Ladder
(11A): Most convex ladder
(12): Recess
(13): Alignment mark
(20): Lower ring body
(21): Ladder
(21A): Most concave ladder
(21B): Most convex ladder
(22): Convex body
(23): Size figures
(30): Adjustment ring
(40): Bike front
(50): Frame head tube

### DETAILED DESCRIPTION OF THE PREFERRED EMBODIMENTS

The structural components, technical means and effect reached of the present invention will be further specifically explained as following, through examples coordinated with drawings.

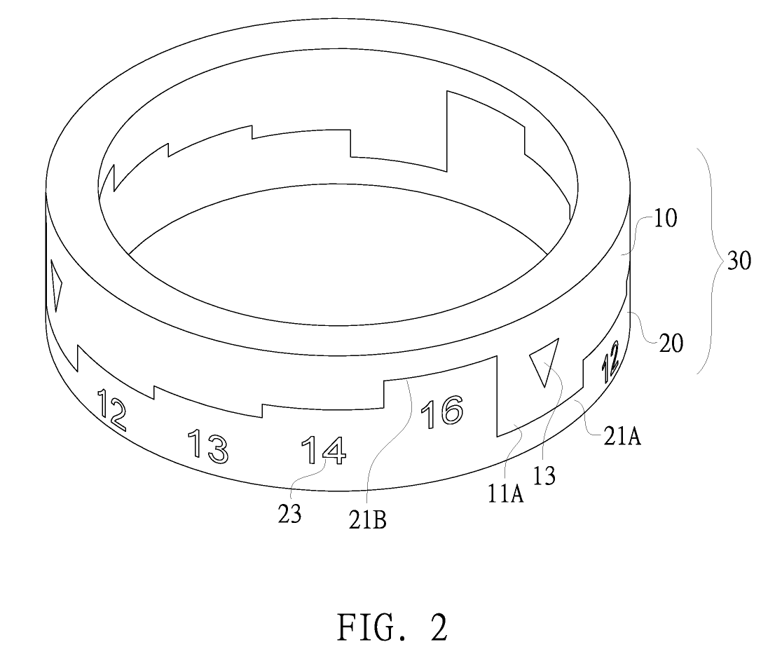

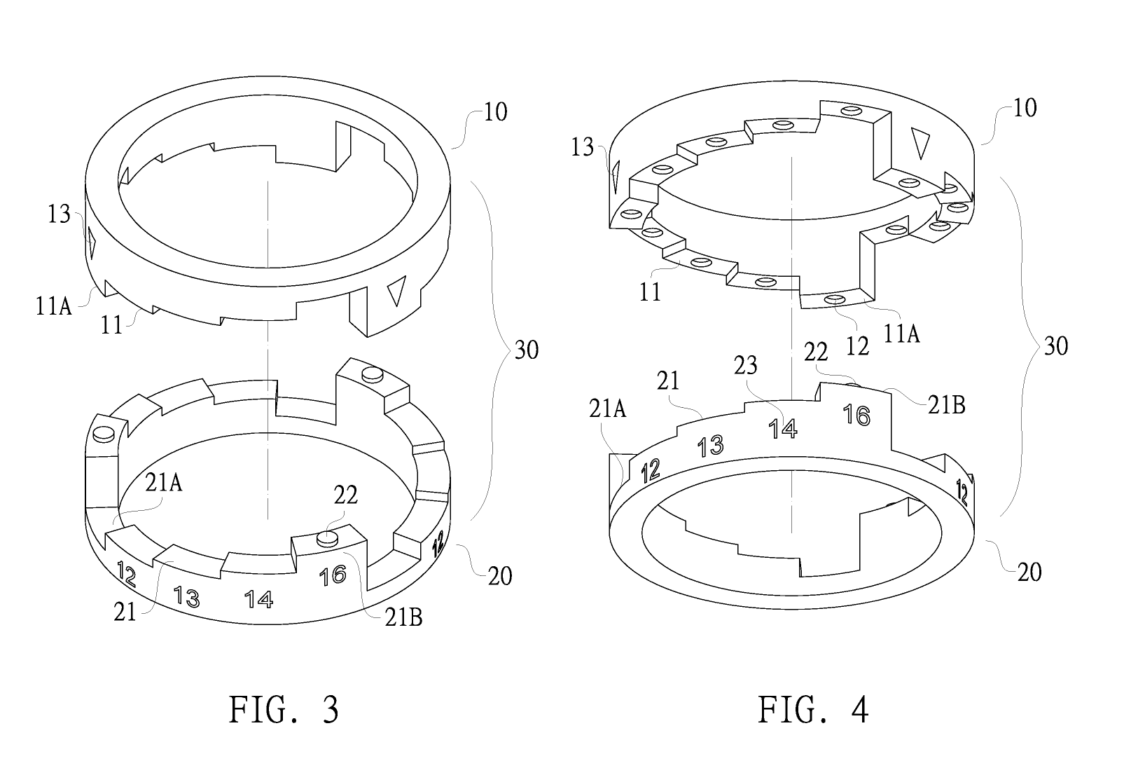

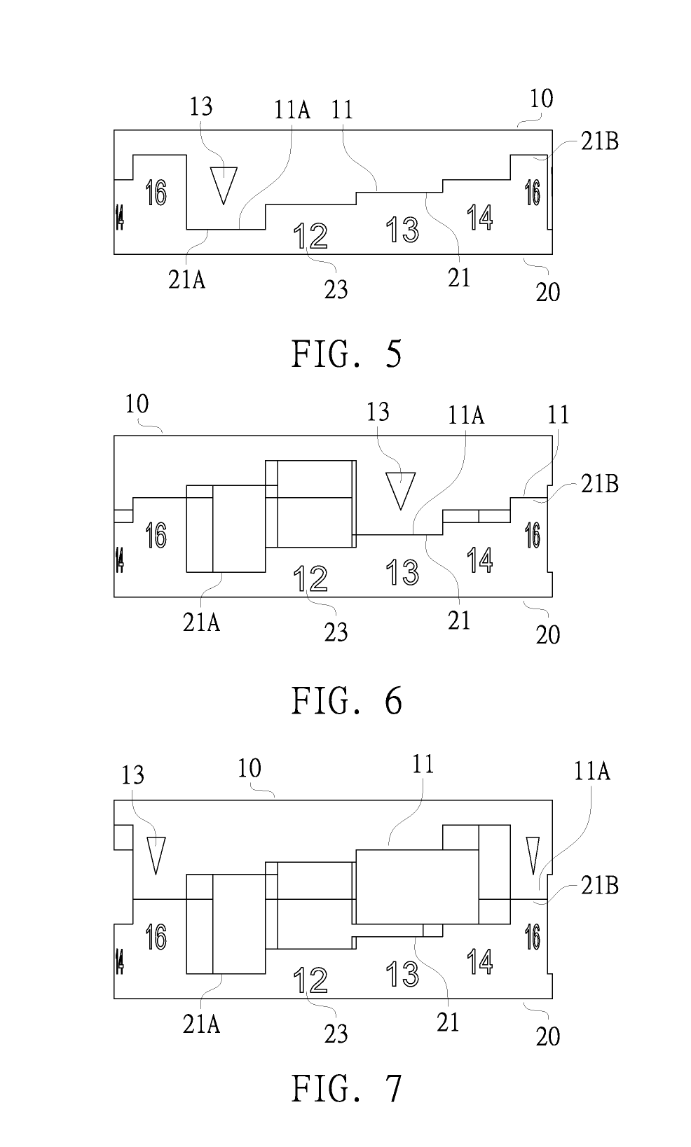

Referring to the structural schematic view of FIG. 2, the structural exploded schematic views of FIGS. 3 and 4, the structural relationship schematic views of FIGS. 5 to 7, and the implementation status reference view of FIG. 8, which show a preferred embodiment of the present invention applying to the adjustment for the supporting height of the bike front. As shown in the drawings, the structural design of the height adjustment ring spacer of the present invention is mainly constituted by a ring-type gasket including at least an upper ring body (10) and at least a lower ring body (20), in which at least two or more (it is three in the drawing) plural staircase-type ladders (11) and (21) are individually placed at the upper annulus of the upper ring body (10) and the lower annulus of the lower ring body (20) in the stacking interface therebetween, the ladders (11) and (21) of the upper and lower ring bodies (10) and (20) are bump engaged, such ladders (11) and (21) round the annulus of the upper and lower ring bodies (10) and (20) at predetermined interval range to implement decreasing or increasing engagement, and the ladders (11) and (21) are circularly and continuously placed, in addition, a recess (12) is placed at every ladder (11) of the upper ring body (10), and a convex body (22) is only placed at the highest ladder of the lower ring body (20), when the upper and lower ring bodies (10) and (20) overlap and combine each other, which are positioned through plugging between the convex body (22) and the recess (12), and a alignment mark (13) is individually placed at outer surface of every most convex ladder (11A) of the upper ring body (10), and size figures (23) are marked at outer surface of every ladder (21) of the lower ring body (20). The shape or size of the recess (12) formed by every ladder (11) of the upper ring body (10) is in direct proportion to these of convex body (22) formed by the ladders of the lower ring body (20). In practice, the convex body and the recess disclosed in the drawings of the present invention do not be limited to the shape shown in the drawing, and the shape can be modified if the convex body and the recess can be engaged. For example, the recess (12) formed by every ladder of the upper ring body (10) is constituted by a through hole or a slot hole with bottom. The convex body (22) formed by the ladders of the lower ring body (20) is constituted by a cylinder. Thus, the height adjustment ring spacer structure of the present invention is constituted.

Furthermore, in the implementation, the arrangement of the recess (12) placed at the upper ring body (10) and the convex body (22) placed at the ladder of the lower ring body (20) can be swapped, and does not be limited as that, in other words, there are a recess formed in every ladder of the lower ring body, and a convex body formed in the ladder of the upper ring body, thus the recess of the lower ring body and the convex body of the upper ring body relatively plug and link each other, also to avoid the relative movement in circumferential and radial direction therein.

As for the above disclosed structure of the height adjustment ring spacer of the present invention, the assembly of bike front (40) and frame head tube (50) adopts the design, in which the multi-stage ladders (11) and (21) placed at the overlapping lower annulus and upper annulus of the upper and lower ring bodies (10) and (20) are relatively engaged, when the most convex ladder (11A) of the upper ring body (10) engages the different ladder (21) of the lower ring body (20), the various supporting heights for adjustment ring (30) to the bike front (40) are formed, that is, when the most convex ladder (11A) of the upper ring body (10) engages most concave ladder (21A) of the lower ring body (20), the adjustment ring (30) presents the minimum supporting height, when the most convex ladder (11A) of the upper ring body (10) increasingly engages the various ladders (21) of the lower ring body (20), the supporting height of the adjustment ring (30) gradually increases, and when the most convex ladder (11A) of the upper ring body (10) engages most convex ladder (21B) of the lower ring body (20), the supporting height of the adjustment ring (30) is maximum, moreover, because the number of the multi-stage ladders (11) and (21) placed at the upper and lower ring bodies (10) and (20) of the present invention is at least two or more, no matter what engaging status with the ladders (11) and (21) for the upper and lower ring bodies (10) and (20), the stable supporting effect is achieved, and the overlapping and engaging relationship between the upper and lower ring bodies (10) and (20) is firmly maintained through combining with the above-mentioned plugging between the convex body (22) and the recess (12). Thus, as for the combination of the bike front (40) and the frame head tube (50), the supporting height of the adjustment ring (30) is first adjusted on the basis of the figure of the cyclist, then integrated with the combination of the bike front (40) and the frame head tube (50), to further raise the integrated height of the bike front (40), and to achieve the best comfort riding position for the relative relationship between the cyclist and his/her hands, so as to effectively improve the muscle soreness or exercise injury after riding.

Moreover, it is worth noting, even the above embodiment describes the supporting height adjustment for the bike front and the head tube, the application of height adjustment ring spacer of the present invention does not limit to single field of bicycles, but the height adjustment ring spacer of the present invention can be applied to height adjustment for thimble assembly in other fields, to meet the requirement of supporting height adjustment, thus the applications in various fields and numerically equivalent modification according to the structure basis of the application of height adjustment ring spacer of the present invention should be within the range of the claims of the present invention.

From the above, the function of multi-stage supporting height adjustment provided in the height adjustment ring spacer of the present invention through structural component design particularly meets the requirement of supporting height adjustment for bike front handles or thimble assembly in other fields, which effectively resolves the problems and shortcomings of the multi-specification production and a number of assemblies stacked use of the conventional fixed type ring spacer, and matches industrial economic benefits and practical value, overall, which is a superior and innovative design, thus the patent application is filed according to regulations.

1. A height adjustment ring spacer, including a ring-type gasket with at least one upper ring body and lower ring body, in which plural staircase-type ladders formed in a side of each of the upper ring bodies and a side of each of the lower ring bodies make the ladders of the upper ring body and the lower ring body individually be placed at different linking engagements to increase or decrease the height in circumferential direction; the claimed features of the present invention are that: there are a recess formed in every ladder of the above upper ring body, and a convex body formed in every ladder of the lower ring body, thus the recess of the upper ring body and the convex body of the lower ring body relatively plug and link each other to avoid the relative movement in circumferential and radial direction therein.

2. The height adjustment ring spacer as claimed in claim 1, in which the shape or size of the recess formed by every ladder of the upper ring body is in direct proportion to these of convex body formed by the ladders of the lower ring body.

3. The height adjustment ring spacer as claimed in claim 2, in which the recess formed by every ladder of the upper ring body is constituted by a through hole or a slot hole with bottom.

4. The height adjustment ring spacer as claimed in claim 2, in which the convex body formed by the ladders of the lower ring body is constituted by a cylinder.

5. The height adjustment ring spacer as claimed in claim 1, in which a alignment mark is individually placed at outer surface of every most convex ladder of the upper ring body, and size figures are marked at outer surface of every ladder of the lower ring body.

6. A height adjustment ring spacer, including a ring-type gasket with at least one upper ring body and lower ring body, in which plural staircase-type ladders formed in a side of each of the upper ring bodies and a side of each of the lower ring bodies make the ladders of the upper ring body and the lower ring body individually be placed at different linking engagements to increase or decrease the height in circumferential direction; the claimed features of the present invention are that: there are a recess formed in every ladder of the above lower ring body, and a convex body formed in every ladder of the upper ring body, thus the recess of the lower ring body and the convex body of the upper ring body relatively plug and link each other to avoid the relative movement in circumferential and radial direction therein.

7. The height adjustment ring spacer as claimed in claim 6, in which the shape or size of the recess formed by every ladder of the lower ring body is in direct proportion to these of convex body formed by the ladders of the upper ring body.

8. The height adjustment ring spacer as claimed in claim 7, in which the recess formed by every ladder of the lower ring body is constituted by a through hole or a slot hole with bottom.

9. The height adjustment ring spacer as claimed in claim 7, in which the convex body formed by the ladders of the upper ring body is constituted by a cylinder.

10. The height adjustment ring spacer as claimed in claim 6, in which a alignment mark is individually placed at outer surface of every most convex ladder of the lower ring body, and size figures are marked at outer surface of every ladder of the upper ring body.
